(19) United States
(12) Patent Application Publication
(10) Pub. No.: US 2006/0235712 A1
(43) Pub. Date: Oct. 19, 2006

(54) ELECTRONIC SYSTEM AND METHOD TO RETRIEVE, PROCESS, AND MANAGE COMPARISON ASSET INFORMATION FOR INVESTMENTS AND RISK MANAGEMENT INFORMATION SYSTEMS

(76) Inventor: Ricardo E. Rodriguez, Raleigh, NC (US)

Correspondence Address: Ricardo E. Rodriguez, 7448 Silver View Ln., Raleigh, NC, 27613, US

(21) Appl. No.: 11/279,896

(22) Filed: Apr. 16, 2006

Related U.S. Application Data
(60) Provisional application No. 60/672,355, filed on Apr. 18, 2005.

(51) Int. Cl. G06Q 99/00

(52) U.S. Cl. 705/1

(57) ABSTRACT

An asset information management system is provided to facilitate investment information gathering, managing, trending, and sharing of information. In the preferred configuration, at least one computer system is connected to the Internet or other data source via a communications device. The communications device provides electronic data such as public data, market forecast data and parcel historical data based on search criteria. The electronic data can be combined with user information to create output charts, graphs, and reports including market trends, forecasting, and current valuations. The system also provides a function to exchange and/or compare information from two or more users toward buying real estate, selling real estate, exchanging real estate assets, or to offer advice on a valuation. Additionally, the system can be attached to a mapping system such as GIS, or satellite mapping. This invention allows investment messages or advertisements to be sent and received to an electronic device or many.

### CROSS REFERENCE TO RELATED APPLICATIONS

The present application claims the benefit of U.S. Provisional Application Ser. No. 60/672,355 filed Apr. 18, 2005, which is incorporated by reference herein in its entirety.

### FIELD OF INVENTION

This Invention relates generally to the managing and gathering of information pertaining to investable assets or assets that may fluctuate in price due to changing market conditions. Particularly, this invention relates to a system to manage real estate investment information such as valuations, trends, forecasting and profit/loss data from public records and other available electronic data to minimize risk in light of other investments, employment environment and other economic indicators and to determine the best investment opportunities. Furthermore, the invention relates to the sending and/or receiving of messages or advertisements relating to such investments or actions. Additionally, the invention relates to providing GIS, satellite maps and/or mapping software interfaces to provide visual images of investment property.

### BACKGROUND OF INVENTION

Today, for a large majority of the population, a real estate investment by way of their home where they currently reside is by far their biggest asset and investment vehicle. Yet no tools exist to track and manage this investment without the help of a Realtor or other such agent. Furthermore, even less help is available to manage the risk taking into account other investments and economic data. This system targets an interactive comparison based investment system for the investor whose biggest investment will most likely be their residence or other real estate property. Furthermore, this invention provides an advanced risk management technique that hedges other investments and/or lifestyle decisions to enhance the user's financial outlook. This invention illustrates how this data can be used to benefit homebuyers, home sellers, realtors, realtor office accountants, homebuilders, mortgage brokers, lenders and other investors.

A need exists to combine diverse real estate information retrieved from a variety of repositories in order to better evaluate investment opportunities in comparison of other similar opportunities. This information can include government public data, employment data, user-entered data, recent sales information, historical sales information, localized similar property comparison information and other user's shared information among others.

A further need exists for a system to display comparison data to the user either via an Internet web page running on a web server or a local GUI application running on the user's computer. A further need exists for a system to save the retrieved and manipulated information on a data store located on a web server or locally.

A further need exists to provide a service either through a web site or other electronic system to allow users to buy, sell, trade or auction properties.

### SUMMARY OF THE INVENTION

It is an object of the invention to provide a real estate information retrieval and management system to automate the process of real estate property valuation.

It is a further object of the invention to provide a method of retrieving and analyzing real estate information by merging public data, user data and other information to evaluate investment opportunities that can be saved and/or displayed in a variety of user defined ways.

It is a further object of this invention to provide an e-commerce or similar Internet site to allow users to retrieve and view real estate valuation data for any property. It is a further object of this invention to allow users to sell, buy, trade or auction properties at the e-commerce or similar Internet site.

It is a further object of the invention to provide a system for assessing investment value, trending and risk management. It is a further object of the invention to assist users whose primary investment vehicle is the home where they reside. Furthermore, it is an object of the invention to assist real estate buyers, real estate sellers, Realtors, real estate investors, mortgage brokers, lenders and homebuilders to assess the investment qualities of a property or land.

It is a further object of this invention to assist realtors in marketing their services with the data provided by this system. It is a further object of this invention to provide training for realtors with the assistance of the data provided by this system. It is a further object of this invention to provide data to realtor accounting systems to aid in financial forecasting and other accounting and/or financial tasks.

It is an additional object of this invention to consider economic inflation, taxes at all levels, savings levels and retirement benefits of investors to best analyze the investment risk, forecasting and allocation. It is a further object of this invention to provide a risk management system to a large population of investors whose real estate investment by way of their home where they currently reside is by far their biggest asset and investment vehicle.

Furthermore, it is an object of this invention to help mortgage brokers and lenders reduce risk and manage investment valuations and fluctuations.

Additionally, it is an object of this system to be tied to an earth mapping system such as GIS, Satellite maps or Mapping software.

It is a further object of the invention to provide both the ability to receive and send messages related to investment information or based on user search criteria to and from a data server like the Internet. Additionally, it is a further object for this invention to provide up to date and timely information to the user based on current users searches and current data being analyzed.

The invention may be implemented using a computerized system including at least one computer connected to the Internet, a computer with a Database module, and a computer with a GUI module used to present retrieved and processed information to the user. It is possible that a single computer may be used for all processing.

All of the objects of this invention including the ones detailed above and others will become more apparent in the detailed description of this invention.

### BRIEF DESCRIPTION OF THE DRAWINGS

FIG. 1 is an overview of the preferred process involved in this invention.

FIG. 2 shows the preferred embodiment of the invention system.

FIG. 3 shows the preferred embodiment of the invention apparatus.

FIG. 4 is the high-level system architecture diagram.

FIG. 5 is the preferred embodiment of the main search dialog.

FIG. 6 is the preferred embodiment of the communications module functions.

FIG. 7 is the preferred embodiment of the data parser function table.

FIG. 8 is the preferred embodiment of the database fields and automated information.

FIG. 9 is the preferred embodiment of the main workspace.

FIG. 10 is the preferred embodiment of the automated search data and partial search match list.

FIG. 11 are depictions of sample reports data.

FIG. 12 is the preferred embodiment of the investment average, minimum, maximum Graph.

FIG. 13 is the preferred embodiment of the satellite mapping system interface.

FIG. 14 is the preferred embodiment of the message/advertisement communications system diagram.

FIG. 15 shows the preferred connection between this invention and other real estate electronic systems.

FIG. 16 shows the preferred embodiment of the messaging system connected to external communication devices such as cell phones, PDAs and other electronic messaging systems.

### DETAILED DESCRIPTION OF INVENTION

The present invention now will be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

In the preferred embodiment, the invention allows the tracking of real estate valuations, sale comparisons, trend forecasting, transaction management, directed realtor marketing, information sharing and other real estate information management functions.

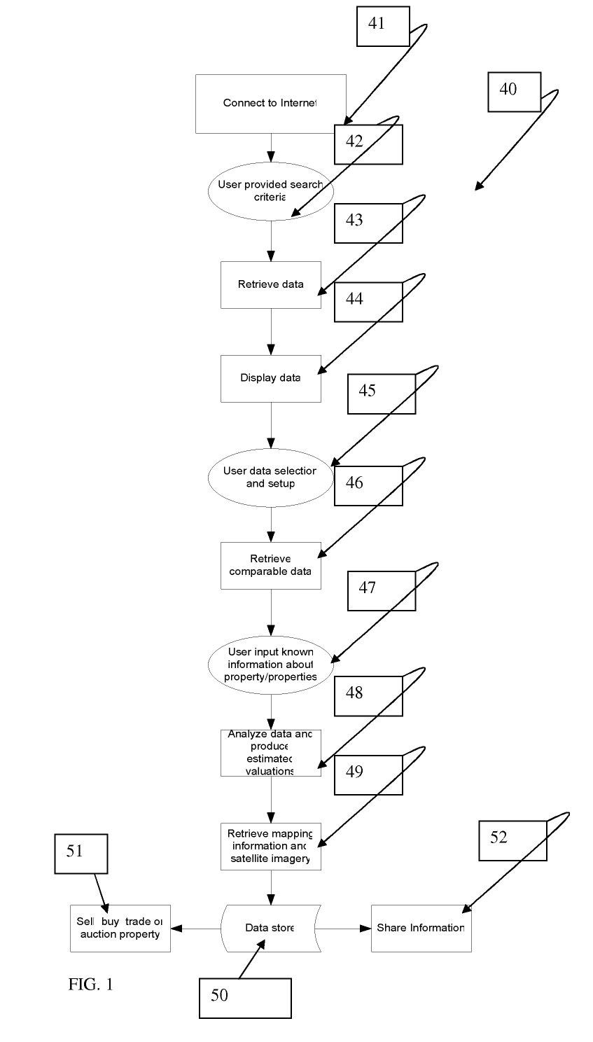

Method 40 in FIG. 1 describes the preferred process for this invention. In the first step 41, a connection to the Internet is acquired. Next, in 42, the user inputs search criteria using either a non-downloadable web or mobile device application or a downloadable application (see 160 in FIG. 5).

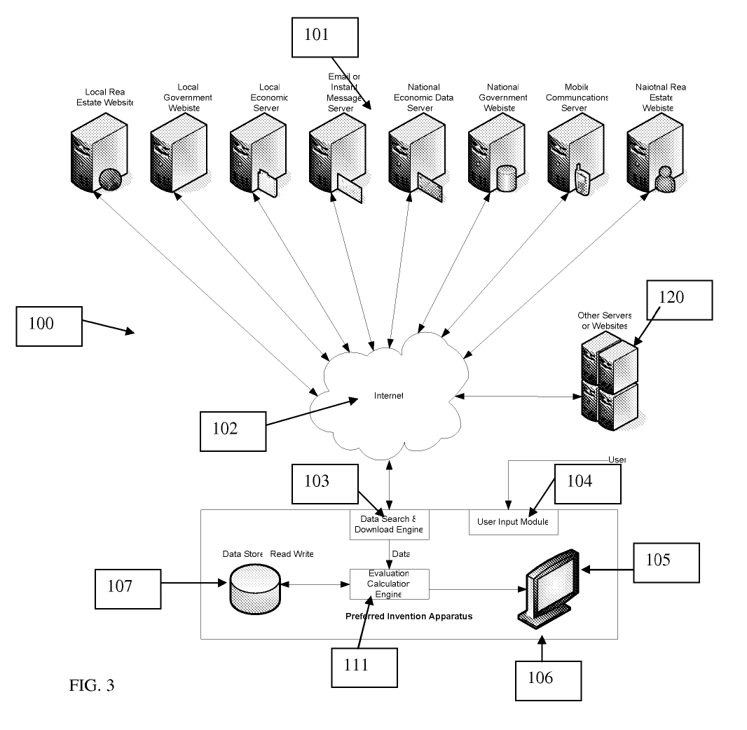

Next, in the preferred embodiment a novel real estate search engine(s) (103 in FIG. 3) are used to retrieve real estate information from a variety of data sources including public data servers, real estate information servers and other government and public servers (43 in FIG. 1). Next, the retrieved information is parsed and displayed in 44 to the user for inspection and further input. The user may then setup his workspace and data views in 45. Additionally, the user may selectively download comparable parcel data in 46 if not already done or if further comparable parcel information is needed. The user may then select to input further information about the parcel in 47 that is know to the user such as room additions, kitchen remodeling or landscaping upgrades.

Next, the selected downloaded data and user input data are used to analyze the data and calculate valuation estimations in 48 such as current parcel value, investment trend, forecasting and future growth estimates.

Next, mapping and/or satellite imagery can be retrieved in 49 to view parcel property pictures and maps and to get property dimensions and other information as to property size and appearance.

Finally, the data can be stored in 50 and/or published and shared in 51 and 52 respectively to a server used to buy, sell, trade or auction real estate property. The data can be stored to a non-downloadable data store on a server or to the user's local hard drive or portable memory device. This can be done by saving the data file for the target parcel along with comparable data which can later be loaded to retrieve the information that was saved.

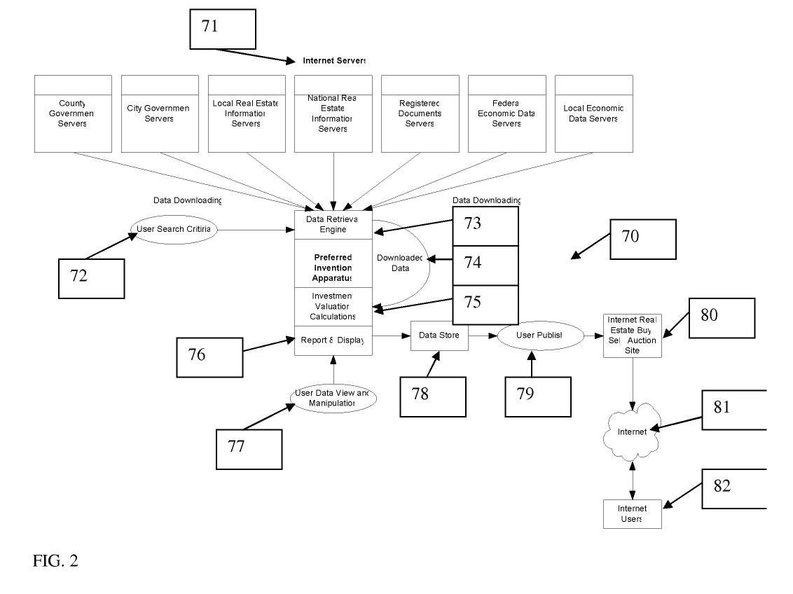

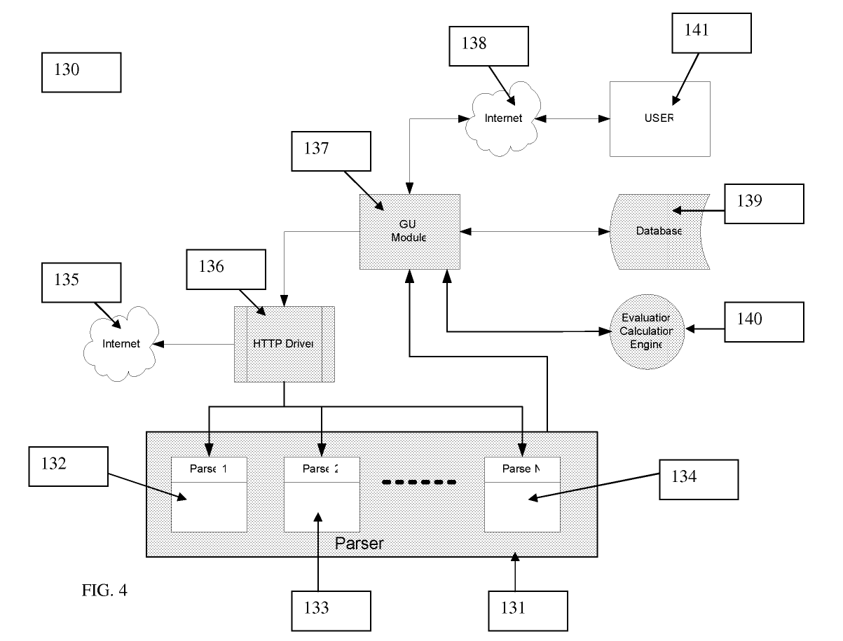

The diagram 70 in FIG. 2 further depicts the preferred embodiment of the invention system. In this system a plurality of economic and real estate information servers 71 can be accessed to retrieve data based on simple search criteria in 72. The Data Retrieval Engine(s) in 73 are then used to retrieve information which is then parsed (132 in FIG. 4) and sent in 74 to the Investment Valuation Calculations module in 75. This module will combine all the information to generate in 76 historical, current and future valuations based on the information for the current parcel (property), comparable parcel, local economic data, and national economic data. Optionally, global economic data can be used in the case of global real estate investment options.

After valuations are completed a user may select to sell or auction their property in 79, 80, and 81 or may just select to save in 78 their information and not publish the information.

Graphs and charts are used to present the valuation data to the user along with textual explanation of results in 77. The information includes estimates on present and future values of the property and investment feasibility based on local home rental rates and loan rates in the case where a loan is used to purchase the property.

The diagram 82 in FIG. 2 further shows how real estate buyers can use the Internet or similar technology to view real estate valuations for the purpose of buying investment property. This is accomplished by the user publishing in 79 their property valuations on a web site or auction site in 80 where Internet (81) users in 82 can search through the properties for investment or living real estate opportunities.

100 in FIG. 3 depicts the preferred embodiment of the invention apparatus. This diagram shows the invention apparatus in 106 connected to the Internet in 102. The Internet provides a plurality of real estate information servers in 101 along with many local and national public data server which include economic data and parcel information again in 101.

The preferred invention apparatus includes one (1) or more Data Search Engines in 103, User Input module in 104, Real Estate Valuation module in 111, Data Store in 107, and Graphical Display in 105.

The user input module in 104 captures user search criteria which in turn is used by the Data Search Engine(s) in 103 to download information. The downloaded information is then combined with additional user input and passed to the Evaluation Calculation Engine(s) in 111 which generate investment valuations given the input data.

At the end of the process the user can view in 105 the resultant calculations on the graphical display and optionally store and/or publish the data in 107.

As discussed above, the present invention can be implemented on a computer network that is connected to the Internet in 102 or similar network infrastructure. The Internet provides a plurality of real estate and economic information in 101 which can be used to calculate real estate property valuations in 111 using historic and current sales comparisons to estimate current and future values.

In this exemplary system 100, common elements are used through out to simplify the explanation, though actual implementations are not limited to this restriction. For example, the graphical display in 105 is shown as a standard computer monitor but any graphical display can be used such as those found on a cell phone, PDA, television, touch panel or other display capable of displaying graphics. Another example is the data store 107 which is shown in a general way but data can be stored in fixed store devices such as a hard drive or portable store devices such as Universal Serial Bus (USB) flash drives. Another example is the Data Search & Download Engine 103 is shown as a single unit but a plurality of units may be used and the data combined for processing. A final example is the Evaluation Calculation Engine in 111 which again is shown as a single unit but a plurality of units may be used to calculate different valuations for any number of different scenarios that may play out in the future. Different scenarios are based on expected economic numbers that may have a range of values instead of a single value. For example, a range of inflation numbers may be used in different calculations so that one calculation uses one number and on the next a different number.

In one aspect, the basic concept of this invention is to use simple user input by way of a property address to retrieve a plurility of public data and real estate information available from a variety of sources in 101, and 120 and combining this information in 106 to generate valuation information for that property based on said downloaded information from 102. Furthermore, satellite imagery, GIS maps and property pictures can be used in a number of ways to allow users to locate the property or drive to the property or get a notion of property dimensions and location.

A non-downloadable application is any software instruction code running on hardware that does not reside on the users hardware. This includes code running on Internet web servers or other networked systems. In the case of non-downloadable software only input/output data is passed between the user and the host server running the application code. A downloadable application is defined as running the application instruction code on the users hardware instead of a server on the Internet.

In the preferred embodiment the system can be split into five (5) modules: the GUI module in 137, the database module (data store) in 139, the HTTP driver in 136, the HTTP data parser module in 131 and the data processor module in 140.

It is the task of the GUI module in 137 to present data to the user in 141 via the Internet in 138 or similar technology and to organize the data in an easy to use layout. The GUI will use a multi-window structure, which will be described later in this document. The database module in 139 will store information related to search results and information provided by the user. The database will be detailed later in this document. The HTTP driver in 136 connects the system application to the Internet in 135 or other data source. The HTTP driver in 136 exports functions to the system application to access the Internet in 135. The HTTP driver is described further below. The HTTP data parser in 131 is used to parse the data retrieved by the HTTP driver in 136 and populate the database module in 139. The data parser in 131 module is further detailed later. Finally, the data processor in 140 is the main data processing function. The data processing function retrieves data from the database module in 139 or Internet in 135 and combines with user provided data from 141 to calculate several trending, valuation, risk management, and forecasting variables for display. See the data processor section for further information.

The system software architecture is depicted in 130 in FIG. 4. Initially, only one parse module in 132 is needed (Parse 1). Additionally, the GUI in 137, Database in 139 and Data processor modules in 140 can be constructed as dynamic link libraries or static libraries.

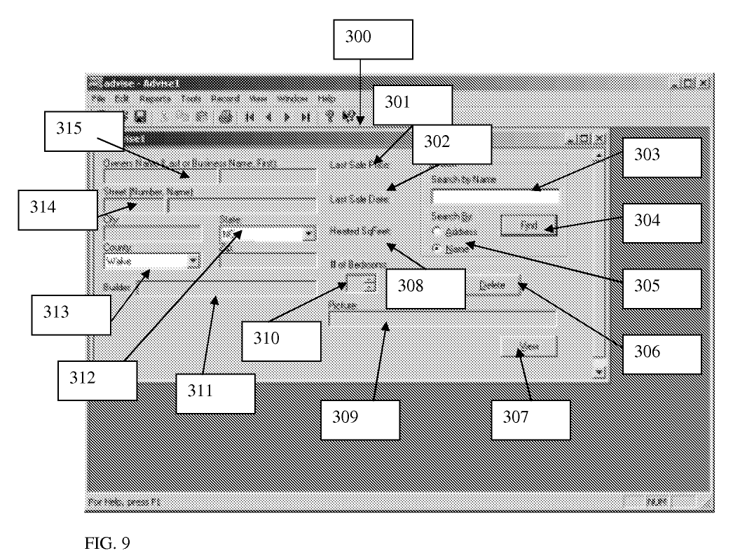

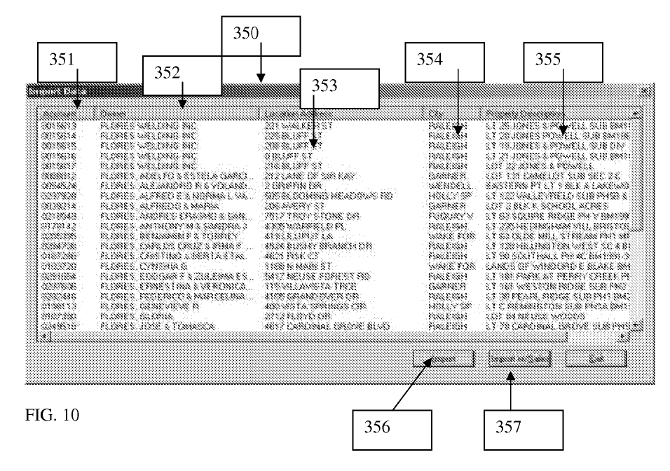

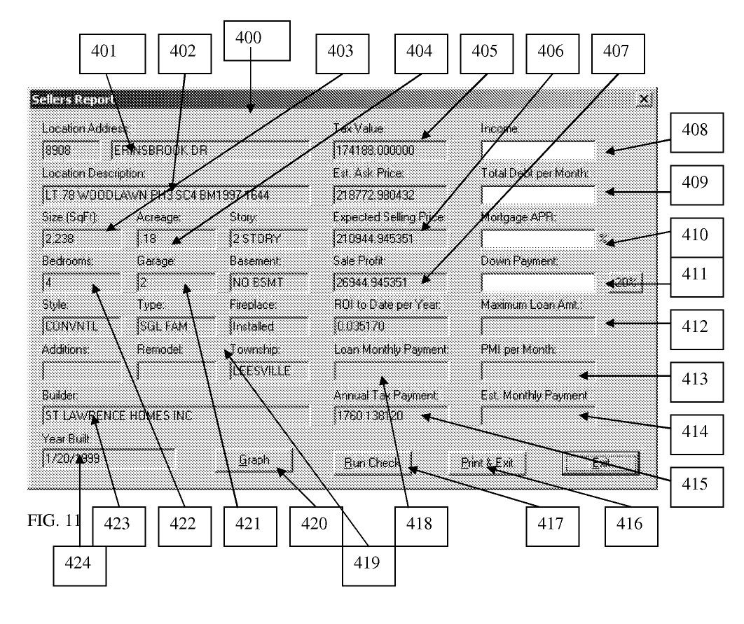

The GUI module in 137 displays processed and user data in one of several views. In the preferred embodiment the system supports three views 300 in FIG. 9, 350 in FIG. 10 and 400 in FIG. 11. The first view displays the initial search dialog 160 in FIG. 5 and 300 in FIG. 9. This is the main dialog for the system. 160 in FIG. 5 and 300 in FIG. 9 are pictures of the initial search dialog.

The main search dialog 300 in FIG. 9 includes several fields including: last name 315, first name 315, business name 315, street number 314, street address 314, City, State 312, County 313, and Zip code. Additional fields may be needed and may be added at a later time. The “Find/Search” 304 button should have focus, as this is the main task performed by this dialog. The “Save” button is used to update the database module when the information is accepted.

The second view 350 in FIG. 10 allows the user to generate a variety of reports including trending, present value, forecasting, and risk management data. It is the main dialog to view and select the Database module information or downloaded data. This has been designed to support all the fields found in 260 in FIG. 8.

The third view displays the results computed by the Data Processor module and selected by the second view dialog 400 in FIG. 11.

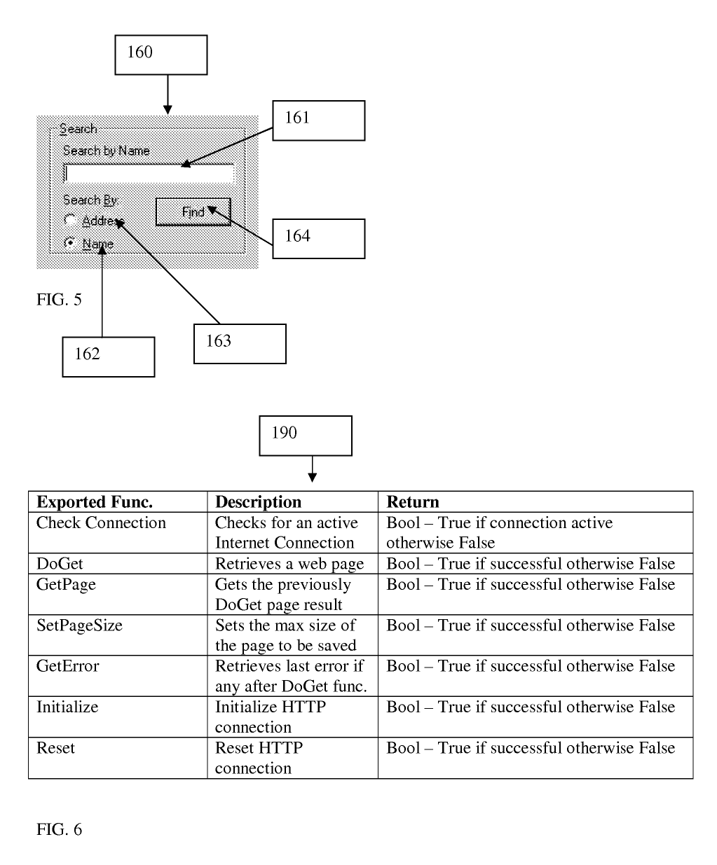

The HTTP module 136 in FIG. 4 exports several functions that support access to the Internet 135 or other HTTP enabled data source. In the preferred embodiment the HTTP driver in 136 will be implemented in a DLL and export the relevant functions. A partial list of supported functions is provided on 190 in FIG. 6.

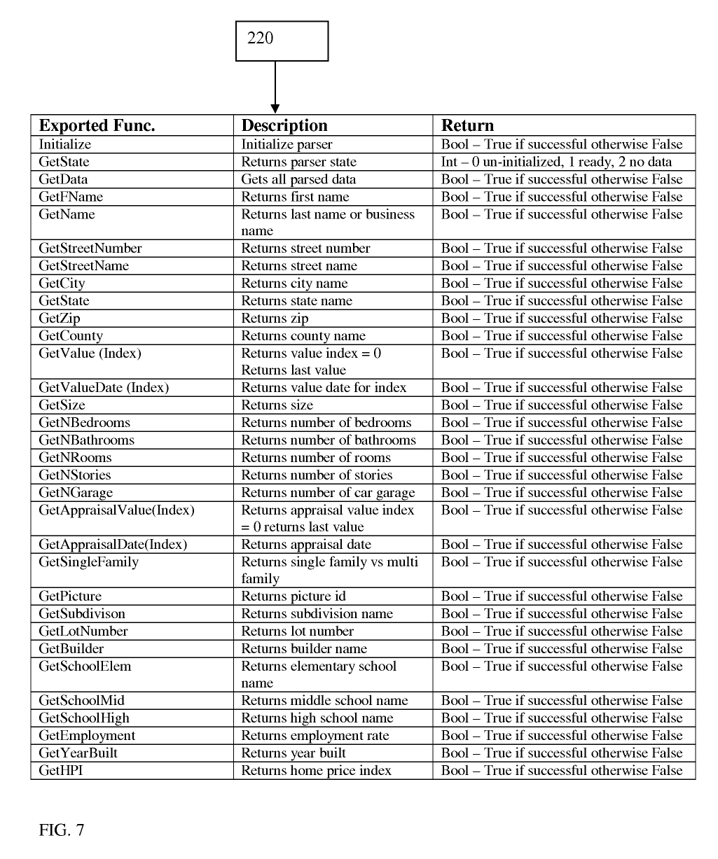

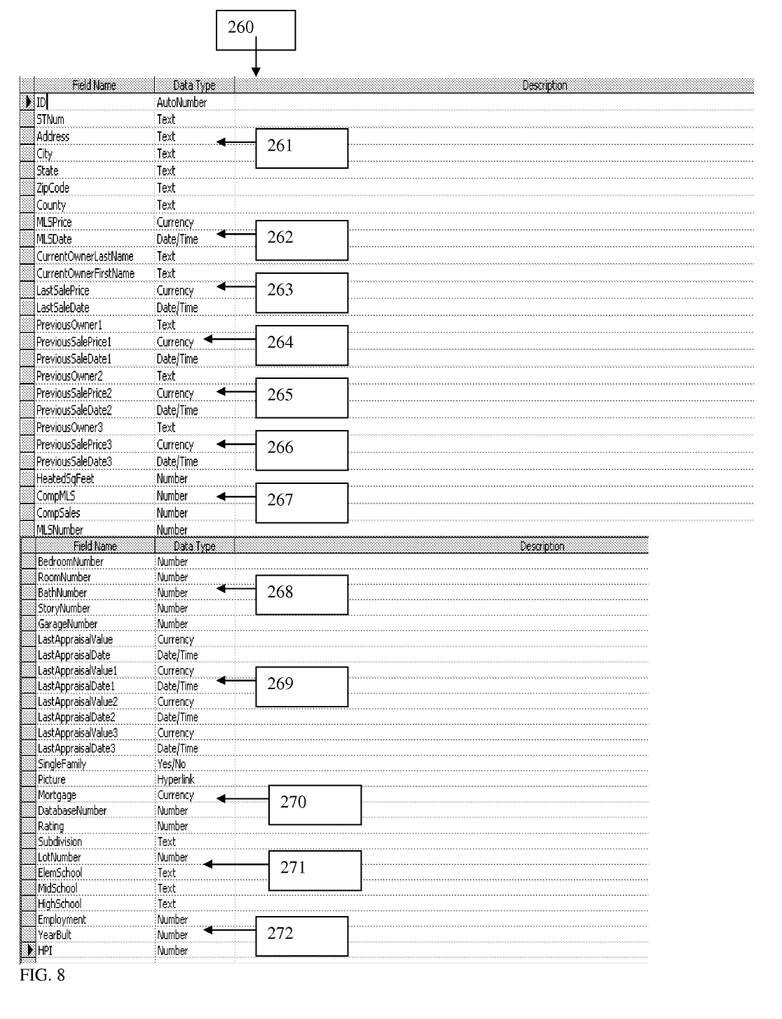

The Parser module 131 in FIG. 4 exports functions used to parse the received data from the Internet. There is one common interface, which all parsers must support. In the preferred embodiment one parser will be written 132. Later, many more parsers 133, and 134 will be written as such the parser must be very modular. In the preferred embodiment, the first parser in 132 will in fact set the interface architecture for the other parsers. In this manner the design should never change the interface once the first parser is written. Function methods may be added but none may be deleted. When architecting the interface one must keep in mind that code sharing will be very valuable, as many parsers will be written. It is therefore necessary to modularize within the parser module to the extent possible. An example function list is shown on 220 in FIG. 7.

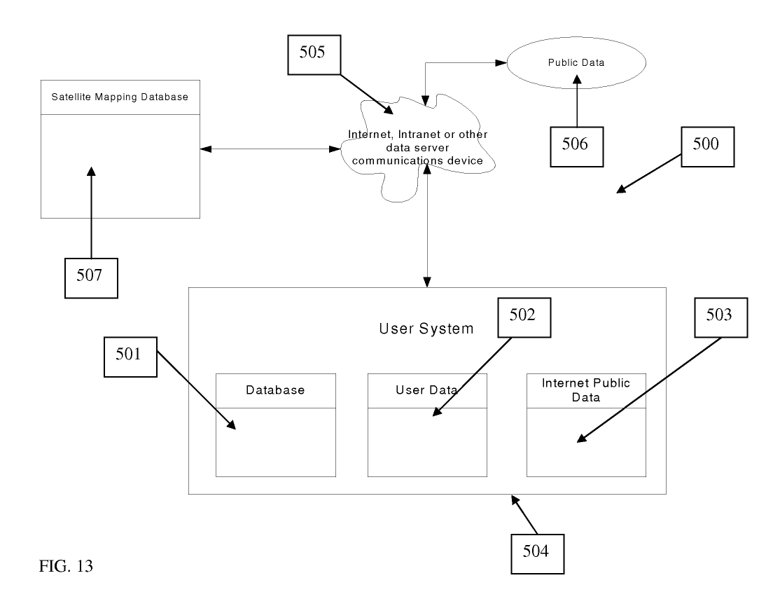

In the preferred embodiment either a Microsoft Access database or Oracle database will be used to store retrieved and user input data 139 in FIG. 4. A relational database will be used to support multiple database matching and field correlation. The relational database can be used to search mapping information such as a satellite mapping system 507 in FIG. 13 by passing the property address to such a system 507 in FIG. 13. In general, any data retrieval system can be used such as the Internet, Intranet or internal/external data retrieval system.

A workspace is used to display several search “environments” at one time. Each search environment can search for an address or owner name 303 in FIG. 9. Given the first few characters of the owner's last name or address the system will present the user with matched results to choose from. The user will then select the appropriate address or last name based on the partial matches. The matches are presented by searching public data on the Internet or other data repository 350 in FIG. 10.

The system search results will present further information found on the property/person of interest 351, 352, 353, 354, and 355 in FIG. 10. This additional data will be used to better pinpoint the target. Data included in the search results will be property description 355, which may contain sub-division information, lot number, City 354, complete address 353 and tax account number 351. After the target property/person has been chosen, the system allows comparatives to be retrieved via an “Import” 356 or “Import with Sales” 357 function that either retrieves the further information for the target property or retrieves further information for the target property and other properties in the neighborhood of the target property or a similar neighborhood elsewhere. 220 in FIG. 7 and 260 in FIG. 8 show some of the information that can be retrieved by the system. Information that is to be retrieved and/or used for calculations include 261 in FIG. 8 property location information, 262 MLS target property listing information, 263 last sale information, 264 previous sale information one sale back, 265 previous sale information 2 sales back, 266 previous sale information 3 sales back, 267 MLS comparable property information, 268 property information as to number of rooms, garage size, baths and bedrooms, 269 appraisal information, 270 property picture and/or diagram and other miscellaneous information, 271 schooling information, 272 Employment index, property built year and Housing Price Index (HPI).

In the case where a single target property is selected, the system can be used to retrieve other information at the direction of the user. In this manner the system is capable of comparing and generating reports based on custom properties for many different areas rather than the system automated “Import with Sales” 357 in FIG. 10 function.

A workspace report view 400 in FIG. 11 will display full address results 401 including but not limited to tax value 405, last sale price 301 in FIG. 9, last sale date 302 in FIG. 9, size 403, sub-division 402, builder 423, style 419, land size 404, additions made to property after initial sale data and any remodeling done 419 in FIG. 11.

The invention further examines the data based on accumulated information (database) and any comparable information found on the Internet and/or information presented by the user. The results are expected selling price 406 in FIG. 11 based on current information and growth projects and return on investment calculations. Additionally, next year's tax payments 415 will be calculated based on public data as well as mortgage information based on user input 408, 409, 410, 411, 412, 413, 414, and 418.

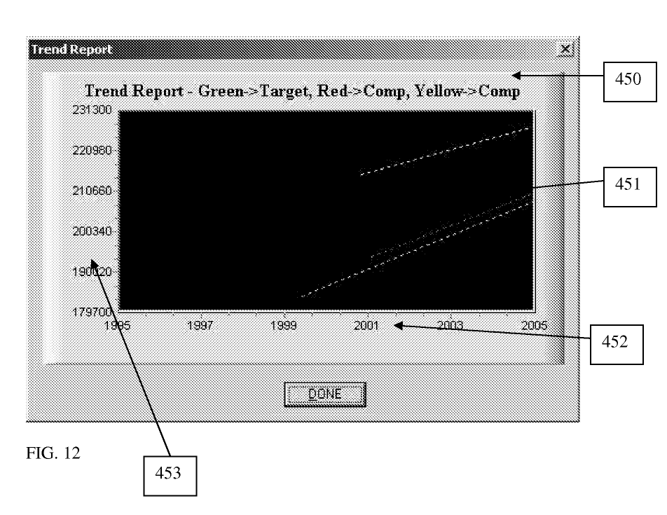

A workspace report graph 450 in FIG. 12 can be generated based on either a single comparable property or the average of several comparable data. Different colors will be used to display the target property vs. average or minimum/maximum comparable data 451, 452 and 453 in FIG. 12.

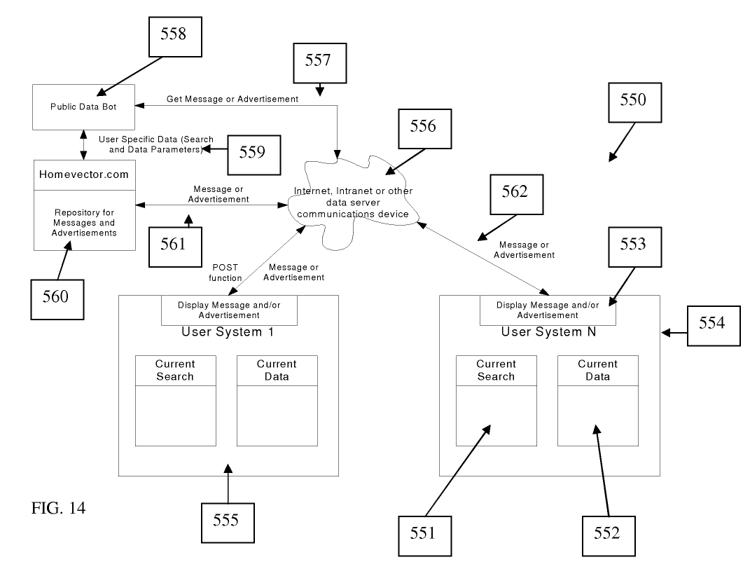

The HTTP communications driver 136 in FIG. 4 further provides a function to send and receive messages and advertisements 560 in FIG. 14, which may or may not be based on the current search or data being analyzed. In the preferred embodiment the HTTP driver 136 can connect to an Internet server 560 and download a message or advertisement as data and/or pictures returned by the server. In the preferred embodiment this is done by sending a POST message 562 to the Internet 556 with current search 551 and/or data 552 variables as parameters. The server 560 will then process these parameters and return up-to-date data that is real-time matched to the current search or data 555 in FIG. 14. The message and or advertisement display 553 in FIG. 14 can change based on which “View” the user is currently working with. In this manner if the user is running a report, a message or advertisement specific to that function is seen. Similarly, the search “View” will cause the message and/or advertisement to present data specific to the search 551 in FIG. 14.

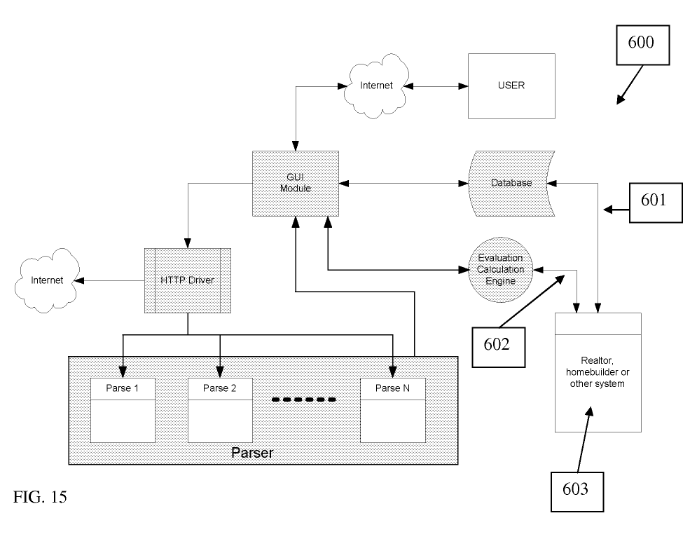

600 in FIG. 15 depicts the two (2) preferred ways 602 and 601 to connect this invention to real estate professional's electronic systems such as MLS systems and accounting systems 603 in FIG. 15.

Both the Evaluation Calculation Engine 140 in FIG. 4 and the Database (Data Store) 139 in FIG. 4 are used to connect to an external system 603 in FIG. 15 such as MLS systems. Software will be used to interface the two systems by receiving or reading data from one system and passing the data to the other system. Bi-directional data passing is achieved by using this method.

A data record is read from the invention Data Store 139 which is then parsed and re-formatted to the format accepted by the external systems 603. Similarly, the external system 603 can pass data in its native format to a software module that will re-format the data to a format this invention recognizes.

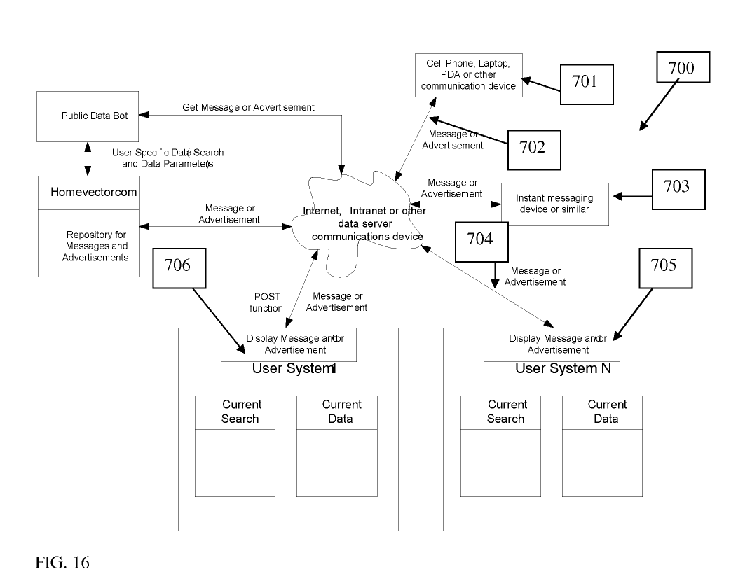

700 in FIG. 16 extends 550 in FIG. 14 to allow users to receive 702 real time or delayed investment information to their cell phones, PDAs or other communication devices 701 and 703. Both text and voice messages can be sent to a communication device 701 and 703 either via a communications server 560 in FIG. 14 or through the Internet 556 in FIG. 14. Voice over IP (VOIP) and text messaging technologies are used to provide this communication service. Graphical data can be sent to cell phones 701 or other similar device with maps to aid in getting to the parcel location(s) and satellite imagery and/or pictures of the parcel land, buildings and homes.

While the present invention is disclosed in a preferred context, it will be recognized that the teachings of the present invention may be variously embodied consistent with the disclosure claims. By way of example, the present invention is disclosed in connection with an Internet connection using certain set of information to estimate certain valuations for real estate investment. It will be recognized that the present teachings may be adapted to user other information and to other present and future network or communication technologies to which they may be beneficial.

What is claimed is:

1. A method of real estate information retrieval, and management comprising:
performing automated data retrieval to acquire parcel or real estate investment information and related comparable parcel information from a single or many different sources of information based on user input search criteria;
using collected comparable and target parcel information to conduct automated investment and value analysis; and
automatically reporting retrieved parcel and comparable parcel information and valuation.

2. The method of claim 1 wherein an Internet server is used to provide user access via a web site and information is displayed via an Internet web page or otherwise non-downloadable or downloadable software to the user's terminal including the means to manage information categories and how the data will be displayed.

3. The method of claim 1 wherein the user input is a property location identifier such as an address and/or a property owner name.

4. The method of claim 1 wherein the Internet is used to retrieve information from public data, tax records, recent sales information, and other electronic data available from government agencies or web sites providing real estate information.

5. The method of claim 1 wherein the user can input known information to augment retrieved information.

6. The method of claim 1 wherein analysis includes current valuation, trend, forecasting, profit/loss calculations and overall investment performance compared to other properties or other investment vehicles.

7. The method of claim 1 wherein consideration for valuation includes local previous sales information, comparable previous sales information, current parcel asking prices, historical price data, economic inflation, taxes, savings rates, and other economic factors that affect the investment.

8. The method of claim 1 wherein a relational database, web site or other electronic data store is used to retrieve mapping data, satellite imagery and/or GIS information.

9. The method of claim 1 wherein the information is stored in a non-downloadable data store and/or saved to the user's local storage area.

10. The method of claim 1 wherein electronic data is interfaced to real estate professionals, mortgage brokers, lenders, homebuilders, and other real estate investor's electronic information storage/management systems.

11. The method of claim 1 wherein property valuation and analysis can be shared and/or placed on real estate searchable buy/sell/trade web sites or other public accessible area such as Realtor.com for others to review for the purpose of selling, trading or otherwise performing a business transaction between two or more parties.

12. The method of claim 1 wherein the advertisement selected is based on current search information or transmission of general advertisements to the user terminals.

13. The method of claim 1 wherein messages are passed between two or more users in multi-cast, two user, or chat room type scenarios to conduct business transactions or to pass information and general communications.

14. The method of claim 1 wherein parcel data can be retrieved with optional neighborhood sales information or as a single parcel.

15. An apparatus for executing real estate data retrieval, data interpretation, and display comprising:
a computer system connected to an information server;
a computer system providing a user interface for search input and results display;
a means to retrieve real estate property information from one or many external information servers; and
a means for automated investment performance calculation using retrieved target and comparable property information.

16. The apparatus of claim 15 wherein the information server is the Internet.

17. The apparatus of claim 15 wherein a messaging system allows communications with other devices such as cell phones, PDAs, Blackberry, laptop computers, or other communications devices to receive voice, text and/or graphical data.

18. The apparatus of claim 15 wherein the data can be stored on the user's computer or using non-downloadable software on the Internet or other on-line data store.

19. A non-downloadable or downloadable computer product comprising a computer readable medium on which is stored program instructions and/or data for a method of:
performing automated data retrieval to acquire parcel or real estate investment information and related comparable parcel information from a single or many different sources of information based on user input search criteria;
using collected comparable and target parcel information to conduct automated investment and value analysis; and
reporting retrieved parcel and comparable information and valuation without any human interaction.

20. The computer program product of claim 19 wherein the programmed instructions and/or data are copied to a computer readable medium for any purpose including sharing of information or distribution.
